(19) United States
(12) Patent Application Publication
(10) Pub. No.: US 2015/0129768 A1
(43) Pub. Date: May 14, 2015

(54) MEASURING APPARATUS AND MEASURING METHOD USING ELECTROMAGNETIC WAVE

(71) Applicant: CANON KABUSHIKI KAISHA, Ohta-ku, Tokyo (JP)

(72) Inventors: Takayuki Koizumi, Yokohama-shi (JP); Oichi Kubota, Kawasaki-shi (JP)

(21) Appl. No.: 14/397,745

(22) PCT Filed: Apr. 23, 2013
(86) PCT No.: PCT/JP2013/062680

§ 371 Date: Oct. 29, 2014

(30) Foreign Application Priority Data
May 11, 2012 (JP) 2012-109394

(51) Int. Cl. G01N 21/3586

(52) U.S. Cl. CPC G01N 21/3586; G01N 2201/06113; G01N 2201/0697; G01N 2201/08
USPC 250/341.1; 250/338.1

(57) ABSTRACT

Provided is a measuring apparatus, including: an irradiation unit configured to irradiate an object to be examined with an electromagnetic wave, the object to be examined being brought into contact with a window member; a sensing unit configured to sense the electromagnetic wave from the object to be examined that is brought into contact with the window member; and a dielectric constant adjusting unit configured to change a dielectric constant of the window member.

### TECHNICAL FIELD

The present invention relates to a measuring apparatus and a measuring method for acquiring information on an object to be examined by using an electromagnetic wave, and more particularly, to a measuring apparatus and a measuring method for acquiring information on physical properties or the like of an object to be examined by using a high-frequency electromagnetic wave in a frequency range from a millimeter wave to a terahertz wave (frequency range from 30 GHz to 30 THz).

### BACKGROUND ART

A THz-time domain spectroscopy (THz-TDS, which is hereinafter referred to also as “terahertz time domain spectroscopy”) apparatus acquires an electric field intensity of a terahertz wave (an electromagnetic wave having a frequency band of at least a portion of a range from 30 GHz to 30 THz is herein referred to also as “terahertz wave”) that arrives in a sensing unit in a form of an ultrashort pulse. The electric field intensity is recorded as needed by changing timings at which the ultrashort pulse arrives in the sensing unit. With this operation, a time waveform of the terahertz wave can be acquired. In addition, when measuring a characteristic absorption of an object to be examined, the object to be examined is irradiated with the terahertz wave, and a time waveform of the terahertz wave from the object to be examined is acquired. The acquired time waveform is transformed into frequency domain information by a Fourier transform, to thereby acquire frequency spectra. Further, when there is a boundary (position at which a refractive index is changed) in the object to be examined, a time waveform including a reflection wave from each boundary in the object to be examined can be acquired. The time waveform including the reflection wave from each boundary has a different arrival time for arriving in the sensing unit due to a difference in each optical path length. Therefore, an internal structure of the object to be examined can be acquired based on the time waveform.

At this time, when a surface of the object to be examined is a thin film and a refractive index difference at an internal boundary of the object to be examined is small, reflection pulses at the surface and the internal boundary may be superimposed on the time waveform. Further, when the reflection at the internal boundary is smaller than the reflection at the surface (the refractive index difference at the internal boundary is smaller), it may be difficult to separate the reflection pulse at the internal boundary from the reflection pulse at the surface without using a numerical calculation or a shorter irradiation pulse. Therefore, it is demanded to separate the time waveform of the reflection wave at the internal boundary from the time waveform of the reflection wave at the surface of the object to be examined without using a shorter pulse of the irradiation electromagnetic wave or a numerical calculation.

On the other hand, in order to acquire the reflection wave at the internal boundary of the object to be examined with high accuracy, it is desired that amplitude of the reflection wave at the surface of the object to be examined be set smaller than amplitude of the reflection wave at the internal boundary of the object to be examined, and preferably, be eliminated. In order to meet this demand, a method can be considered in which a member having a similar refractive index is brought into tight contact with the surface of the object to be examined to reduce the reflection wave at the surface of the object to be examined so that the reflection wave at the internal boundary of the object to be examined is measured with high accuracy. In Non Patent Literature 1, a terahertz wave measurement is performed by pressing a quartz having a similar refractive index to a stratum corneum that is a thin film of a skin surface (having a thickness of 20 μm to 200 μm) against the stratum corneum and using this quartz as a window member (a member optically brought into tight contact with an object to be measured when measuring the object is hereinafter referred to as “window member”). In this case, a reflection wave having amplitude determined by refractive indexes of the window member and the stratum corneum is reflected at a boundary between the window member and the stratum corneum. By performing the measurement with such an apparatus, a reflection at a surface of the stratum corneum can be reduced because the refractive index (dielectric constant) of the window member is closer to that of the stratum corneum in the case where the stratum corneum is brought into contact with the quartz window member, compared to a case where the stratum corneum is brought into contact with the air.

### CITATION LIST

### Non Patent Literature

NPL 1: J. Biomed. Opt. 16, 106010 (Oct. 3, 2011)

However, with the method described in Non Patent Literature 1, reflection pulses at a boundary of a stratum corneum inside the skin and an epidermis have not been sufficiently acquired with high accuracy. The reason is as follows. The refractive index of the window member is not variable but fixed, and hence the refractive index difference between the window member and the stratum corneum that is different for each portion of a body or between individuals is not always sufficiently small to enable separation of the reflection wave at the boundary of the stratum corneum and the epidermis without using a numerical calculation. In addition, even when the reflection wave at the stratum corneum can be separated from the reflection wave at the boundary of the stratum corneum and the epidermis by using a numerical calculation, in a case of obtaining frequency spectra by performing a Fourier transform on each time waveform, a portion of a signal is removed as a noise, which is not suitable for a highly-accurate measurement.

### SUMMARY OF INVENTION

In view of the above-mentioned problems, according to an exemplary embodiment of the present invention, there is provided a measuring apparatus, including: an irradiation unit configured to irradiate an object to be examined with an electromagnetic wave, the object to be examined being brought into contact with a window member; a sensing unit configured to sense the electromagnetic wave from the object to be examined that is brought into contact with the window member; and a dielectric constant adjusting unit configured to change a dielectric constant of the window member.

According to the present invention, the window member that is configured to change the dielectric constant is brought into contact with the object to be examined, the object to be examined that is brought into contact with the window member is irradiated with the electromagnetic wave, and the electromagnetic wave from the object to be examined that is brought into contact with the window member is sensed. Accordingly, the electromagnetic wave from the object to be examined that is brought into contact with the window member can be sensed in a state in which the refractive index difference at the boundary between the surface of the object to be examined and the window member is adjusted. Therefore, the refractive index difference at the boundary between the surface of the object to be examined and the window member can be adjusted in a flexible manner as appropriate. For example, regarding an object to be examined in which a surface of the object to be examined is a thin film and the refractive index difference at a boundary inside the object to be examined is small, amplitude of the reflection wave at the surface of the object to be examined can be reduced. As a result, a slight reflection wave from the boundary inside the thin film can be sensed with high accuracy.

Further features of the present invention will become apparent from the following description of exemplary embodiments with reference to the attached drawings.

### BRIEF DESCRIPTION OF DRAWINGS

FIG. 1 is a schematic diagram illustrating a configuration of a measuring apparatus according to a first embodiment of the present invention.

FIG. 2A is a schematic diagram illustrating an example of a window member according to the first embodiment.

FIG. 2B is a schematic diagram illustrating the example of the window member according to the first embodiment.

FIG. 3A is a graph showing an example of an operation of the measuring apparatus and method.

FIG. 3B is a graph showing an example of the operation of the measuring apparatus and method.

FIG. 4 is a diagram illustrating an example of a step of adjusting the dielectric constant of the window member.

FIG. 5 is a diagram illustrating a window member according to a second embodiment of the present invention.

FIG. 6 is a diagram illustrating a window member according to a fourth embodiment of the present invention.

FIG. 7 is a diagram illustrating a fifth embodiment of the present invention.

FIG. 8 is a diagram illustrating a window member according to a sixth embodiment of the present invention.

### DESCRIPTION OF EMBODIMENTS

The present invention has a feature in that the dielectric constant of a window member that is brought into contact with an object to be examined can be adjusted, the object to be examined that is brought into contact with the window member with the dielectric constant adjusted as appropriate is irradiated with an electromagnetic wave, and the electromagnetic wave from the object to be examined that is brought into contact with the window member is sensed. The electromagnetic wave is typically a pulse of a terahertz wave as is described in the following embodiments and examples. However, a continuous wave can be used as well. In the case of the continuous wave, a magnitude change of the intensity of the reflection wave from each boundary due to a phase difference is sensed by using a technology of an interferometer. In this manner, a structure of the object to be examined (such as a distance between boundaries) can be sensed. However, compared to the case of measuring a time waveform by using an electromagnetic wave pulse, it is hard to sense characteristics such as a refractive index of the object to be examined, and even when the present invention is applied, the resolution is degraded more or less. In addition, the reflection wave at the boundary can also be sensed from the electromagnetic wave transmitted through the object to be examined, by arranging an irradiation unit, a sensing unit, and a window member in a transmission system with respect to the object to be examined. In this case as well, the same effect can be obtained as in the case of the reflection configuration. Further, the window member can also take a role of, in addition to adjusting the refractive index difference between the window member and the surface of the object to be examined, smoothing the surface of the object to be examined by eliminating unevenness of the surface of the flexible object to be examined along a surface profile of the window member. In this manner, the present invention is not limited to the contents of the following embodiments and examples, but various modifications and replacements may be made without departing from the spirit of the present invention.

### First Embodiment

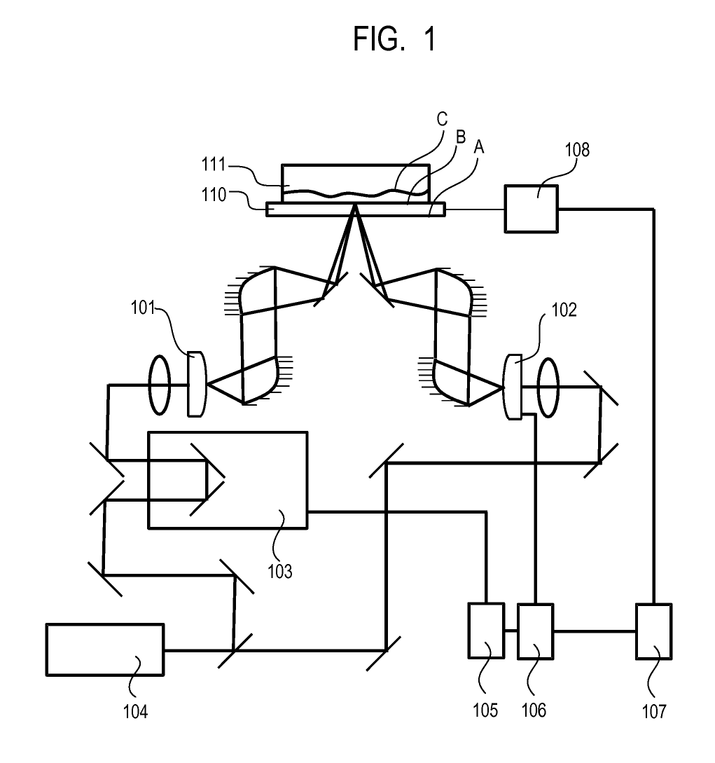

A measuring apparatus for measuring an object to be examined by using a terahertz wave according to a first embodiment of the present invention is described with reference to FIG. 1. As illustrated in FIG. 1, the apparatus includes a portion for building a time waveform of the terahertz wave pulse in a time domain, a portion for detecting a change of the dielectric constant or the like of a window member based on a reflection pulse from the object to be examined, the window member having a variable dielectric constant, and a mechanism for adjusting the dielectric constant of the window member. The portion for building the time waveform of the terahertz wave pulse in the time domain is the same as a general terahertz time domain spectroscopy apparatus such as the apparatus described in Non Patent Literature 1. That is, this portion includes an irradiation unit 101, a sensing unit 102, an optical delay unit 103, a pulse laser source 104, a control unit 105, and a time waveform acquiring unit 106.

The irradiation unit 101 is a portion for generating a terahertz wave pulse. A method of generating the terahertz wave at the irradiation unit 101 includes a method of using an instantaneous current and a method of using an interband transition of a carrier. As the former method of using the instantaneous current, there can be applied a method of generating the terahertz wave by irradiating a surface of a semiconductor or an organic crystal with laser light, and a method of applying an electric field to a photoconductive element obtained by forming an antenna pattern on a semiconductor thin film with a metal electrode and irradiating an electric field application portion with laser light. Further, a PIN diode can be applied as well. As the latter method of using a gain structure, a method of using a semiconductor quantum well structure such as a resonant tunnel diode (RTD) and a quantum cascade laser (QCL) can be applied.

The sensing unit 102 is a portion for sensing the electric field intensity of the terahertz wave pulse. A sensing method of the sensing unit 102 includes a method of sensing a current corresponding to the electric field intensity by a photoconduction, a method of sensing an electric field by using an electro-optical effect, and a method of sensing a magnetic field by using a magneto-optical effect. As the method of sensing the current by the photoconduction, a method of using a photoconductive element can be applied. As the method of sensing the electric field by using the electro-optical effect, a method of using an orthogonal polarizer and an electro-optical crystal can be applied. As the method of sensing the magnetic field by using the magneto-optical effect, a method of using an orthogonal polarizer and a magneto-optical crystal can be applied. A sensing sensitivity of the terahertz wave that enters the sensing unit 102 can be increased by focusing the terahertz wave on the sensing unit 102 to increase the intensity per unit area.

The pulse laser source 104 is a portion for outputting an ultrashort pulse laser. The irradiation unit 101 and the sensing unit 102 are operated through an excitation of a carrier by the ultrashort pulse laser. In this embodiment, as illustrated in FIG. 1, the ultrashort pulse laser is split into two optical paths. The pulse laser that passes through the optical delay unit 103, which is described later, is input to the irradiation unit 101. The ultrashort pulse laser that passes through the other path is input to the sensing unit 102. The optical delay unit 103 is a portion for adjusting a sampling position at the sensing unit 102 among the time waveforms of the terahertz wave pulse. Specifically, the optical delay unit 103 delays or changes a timing of the ultrashort pulse laser to be input to the sensing unit 102 with respect to the ultrashort pulse laser to be input to the irradiation unit 101. An adjustment of the delay time is performed by the control unit 105, and a method of adjusting the delay time includes a method of directly adjusting the optical length and a method of adjusting the effective optical length. The method of directly adjusting the optical length includes a method of using a folding optical system and a moving unit. The method of adjusting the effective optical length includes a method of changing a time constant or a refractive index on a path, through which a trigger signal propagates, by using an electro-optical crystal. The example in FIG. 1 is an example of using the folding optical system and the moving unit.

The time waveform acquiring unit 106 is a portion for building a time waveform of the terahertz wave pulse. The time waveform is built based on the adjustment amount by the optical delay unit 103 and an output of the sensing unit 102. When obtaining the frequency spectra, a Fourier transform is performed on this time waveform. When a THz-TDS apparatus is used as the measuring apparatus, a change of the time waveform when an object 111 to be examined is irradiated with the terahertz wave is obtained. Further, the object 111 to be examined can be visualized by associating a relative position of the object 111 to be examined and the irradiation terahertz wave with information of the control unit 105 that controls position information of the optical delay unit 103. The above-mentioned configuration is a general configuration known as the THz-TDS apparatus.

Further, in this embodiment, a window member 110 is brought into contact with the object 111 to be examined that includes a two-layer structure having a boundary C therein, and to the window member 110, a dielectric constant adjusting unit 108 for adjusting the dielectric constant of the window member 110 is connected. Further, a dielectric-constant change detecting unit 107 is provided so as to calculate the dielectric constants and changes of the dielectric constants of the window member 110 and the object 111 to be examined based on the time waveform acquired by the time waveform acquiring unit 106.

In this embodiment, the irradiation unit 101 and the sensing unit 102 are disposed so as to be a reflection configuration with respect to the window member 110 and the object 111 to be examined. The terahertz wave generated from the irradiation unit 101 is focused on boundaries (boundaries A, B, and C) of the window member 110 and the object 111 to be examined, and a portion of the entered terahertz wave pulse is absorbed and scattered in accordance with a physical property of the area on which the terahertz wave pulse is focused. The reflection terahertz wave pulse is then focused on the sensing unit 102, which is eventually entered and measured. In the time waveform sensed by irradiating the object 111 to be examined having the above-mentioned configuration with the terahertz wave, when an optical length difference between the boundary B (boundary between the window member and the object to be examined) at the surface of the object 111 to be examined and the boundary C inside the object to be examined is small, each reflection pulse is superimposed. With this situation, when acquiring the frequency spectra of the boundary C, the reflection pulse at the boundary B needs to be separated on the time waveform, which is not suitable for a highly-accurate measurement.

In order to acquire the information of the internal boundary C of the object 111 to be examined with high accuracy, it is effective to detect the dielectric constant (refractive index) of the window member 110 and to adjust the dielectric constant of the window member 110 so that the reflection at the boundary B is sufficiently suppressed (i.e., the refractive indexes of the window member and the surface of the object to be examined sufficiently match each other). By adopting such a configuration, the reflection pulse at the boundary B can be eliminated or can be suppressed to a sufficiently small value with respect to the reflection amplitude at the boundary C on the time waveform.

When detecting the dielectric constant of the window member 110 and each layer (portion sandwiched by boundaries) of the object 111 to be examined, the time waveform of the terahertz wave pulse acquired by the time waveform acquiring unit 106 is transferred to the dielectric-constant change detecting unit 107. The method of calculating the dielectric constant is executed, for example, in the following manner. A surface of a reference metal mirror (hereinafter referred to as “reference”) having a reflectance of substantially 100% and a desired boundary are set at the substantially same position, and the time waveforms of reflection pulses at the reference and each portion of the object 111 to be examined are measured. The Fourier transform is performed on each of the time waveforms, and the frequency spectra are acquired. A complex amplitude reflectance can be calculated by taking an amplitude ratio and a phase shift of the reference and each portion of the object 111 to be examined on the frequency axis. Further, a complex refractive index and a complex dielectric constant of the window member and each portion of the object to be examined can be calculated by separating a real part and an imaginary part of the calculated complex amplitude reflectance from each other. In this manner, the dielectric-constant change detecting unit detects a change of the dielectric constant of the window member from a sensing signal of the sensing unit. That is, the change of the dielectric constant of the window member is detected by calculating the complex amplitude reflectance based on the signal of the reflection wave at the window member that is sensed by the sensing unit and calculating the complex refractive index and the complex dielectric constant based on the complex amplitude reflectance.

When detecting the change of the dielectric constant of the window member 110, it is desired that the reference be measured each time the dielectric constant of the window member 110 is changed. In addition, it is required to match the relative positions of the reference and the measurement surface of the object to be examined with the accuracy within about 1 μm. From this background, it is desired to provide the reference to a part of the window member in a manner that the positions are aligned (refer to a third embodiment of FIG. 6 that is described later).

The dielectric-constant change detecting unit 107 is configured to detect the dielectric constant by performing the above-mentioned process based on the time waveform of the reflection pulses at the reference and each portion of the object 111 to be examined, and to transfer the result to the dielectric constant adjusting unit 108. The dielectric constant adjusting unit 108 includes a mechanism for changing the dielectric constant of the window member 110. It is desired that the result of the dielectric constant of the window member 110 that is calculated by the dielectric-constant change detecting unit 107 be transferred to the dielectric constant adjusting unit 108, and the dielectric constant of the window member 110 be changed based on the result. When changing the dielectric constant of the window member 110, the detection and the adjustment of the dielectric constant may be performed in an alternate manner or at the same time. It is preferred that the dielectric constant of the surface of the object 111 to be examined be measured in advance, and the dielectric constant of the window member be adjusted to be close to the dielectric constant of the surface of the object 111 to be examined. That is, based on the signal from the boundary between the window member and the surface of the object to be examined, the dielectric constant adjusting unit may adjust the dielectric constant while involving a step of reducing the refractive index difference between the window member and the surface of the object to be examined.

In addition, a database is acquired in advance regarding a correlation between the control amount of the dielectric constant adjusting unit 108 that controls the window member 110 and the change amount of the dielectric constant of the window member 110, and after measuring the dielectric constant of the surface of the object 111 to be examined, the dielectric constant of the window member 110 may be adjusted by referring to the database. That is, in an example of a liquid-infiltration-amount adjusting unit, which is described later, an adjustment of a liquid infiltration is performed by using a database that stores a relationship between the complex refractive index (complex dielectric constant) of the porous material and at least one of information on the porous material (such as thickness, porosity, and material property) and information on the liquid (such as concentration, infiltration amount, and mixture ratio) or a combination of the pieces of information. Further, it is desired that the dielectric constant of the window member 110 be adjusted depending on information on which portion of the object 111 to be examined is required. For example, when the information on the boundary B of the object 111 to be examined (i.e., a portion of the object 111 to be examined that defines the boundary B) is to be acquired, the information on the boundary C is not necessary. In this case, in order to increase the reflection at the boundary B as much as possible, it is preferred that the dielectric constant (refractive index) difference between the boundary B (i.e., the portion of the object 111 to be examined that defines the boundary B) and the window member 110 be increased. On the other hand, when the information on the boundary C is to be acquired, the information on the boundary B is not necessary. In this case, in order to reduce the reflection at the boundary B as much as possible, it is preferred that the dielectric constant (refractive index) difference between the boundary B (i.e., the portion of the object 111 to be examined that defines the boundary B) and the window member 110 be decreased.

Conventionally, it has been required to select a window member having a suitable refractive index (dielectric constant) in each case in accordance with the refractive index (dielectric constant) of the object 111 to be examined and measured, and a configuration of the boundary from which the information is needed. However, according to the present invention, the mechanism for adjusting the dielectric constant of the window member 110 is provided, and hence an adjustment can be easily performed on the window member 110 having a dielectric constant suitable for acquiring the information on the desired boundary.

The material of the window member 110 includes, for example, a mechanism for infiltrating a liquid by a capillary force, a surface tension, or the like. Further, a material having a high transmittance with respect to the electromagnetic wave used is desired. An example of the material having the high transmittance includes a porous material of granulated shape or sponge structure of polypropylene, polysulfone, nylon, or polyethersulfone. Another structure of the window member 110 includes a fiber material and a needle-like structure. In order to avoid a scattering of the terahertz wave to be irradiated, it is desired that a dimension of the microstructure of these materials (pore diameter in the case of the porous material, thickness of the fiber or distance between fibers in the case of the fiber material, and thickness of the needle or distance between needles in the case of the needle-like structure) be sufficiently smaller than the wavelength of the terahertz wave, i.e., several tens of μm or smaller. Further, the porous material may include multiple structures having different material property, hydrophilic property, and hydrophobic property. However, the material and the form of the window member are not limited to the above-mentioned material and form.

It is desired that the liquid supplied to the window member 110 by the dielectric constant adjusting unit 108 include, for example, at least one of water, saline, oil, ionized water, formalin, phosphate buffer solution, alcohol, cell culturing medium, sugar, hormone, protein, amino acid, organic compound, and cytokine. Further, it is preferred to use a liquid that less absorbs the terahertz wave. In addition, the liquid to be infiltrated into the window member may be a single type of liquid or a mixture of two types or more liquids. The liquids may be infiltrated separately into different places of the window member. Although it is desired that the liquid be mixed at the above-mentioned dielectric constant adjusting unit 108, it is also possible to mix the liquids while separately infiltrating the liquids into the window member 110. The dielectric constant adjusting unit 108 may include an infiltrating unit for infiltrating a liquid of at least one type into the window member, and a liquid-infiltration-amount adjusting unit for independently adjusting an infiltration amount of the liquid.

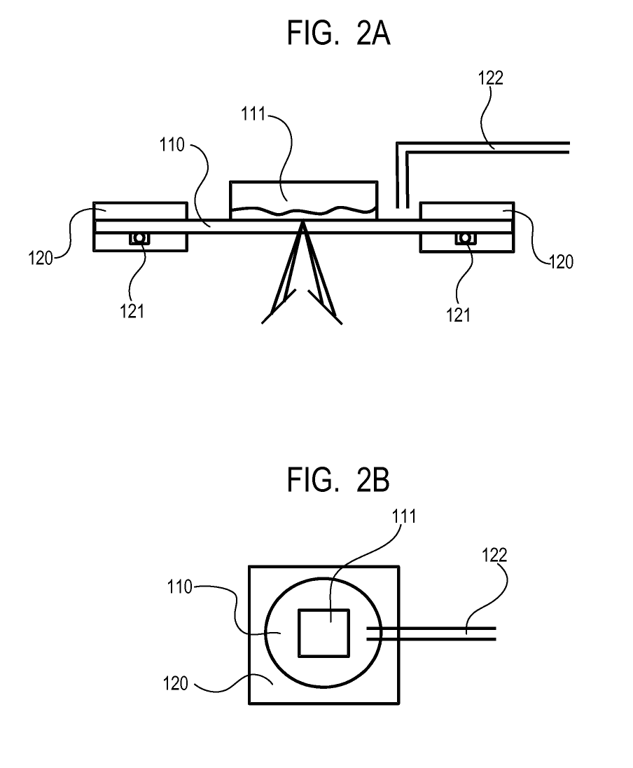

A specific example of the window member according to the first embodiment is further described with reference to FIGS. 2A and 2B. FIG. 2A is a detailed cross-sectional view of a measurement area of the object 111 to be examined. FIG. 2B is a plan view of the measurement area. In the measuring apparatus used in the example illustrated in FIGS. 2A and 2B, the window member 110 is fixed by sandwiching the window member 110 from both sides with an O ring 121 and a window member fixing jig 120. The window member fixing jig 120 includes a circular hole so that when the window member fixing jig 120 sandwiches the window member 110, a center portion of the window member 110 is exposed to outside. The object 111 to be examined is set on this portion of the window member 110. The terahertz wave is used to irradiate the object 111 to be examined so that the terahertz wave passes through the exposed portion of the window member 110.

By fixing an outer circumference of the window member 110 in a circular manner with the O ring 121, a uniform tension can be generated in a radial manner toward the outer side. In addition, a force of sandwiching the window member 110 with the O ring 121 and the window member fixing jig 120 is adjusted by controlling a pressing force of the O ring 121 so that a tension exerting in a plane direction of the window member 110 can be adjusted. In this manner, even when a heavy object 111 to be examined is placed, the window member 110 can maintain a planar shape without being deflected. By maintaining the planar shape of the window member 110, an unnecessary scattering of the terahertz wave at the window member 110 can be suppressed, enabling a highly-accurate measurement. Further, when a porous material is used as the material for the window member 110, the infiltration of the liquid can be performed by dripping the liquid from above the window member 110 through a liquid flow channel 122. The dripped liquid can be uniformly seeped into the window member 110 by the capillary force, the surface tension, or the like. A method of dripping the liquid onto the window member 110 may be implemented by using, for example, an injecting unit, such as a commercially available micro injector or pipette, which can drip a micro liquid droplet. Multiple injecting units may be used.

When it is desired to uniformly seep the liquid more rapidly than in the dripping method, it is desired to provide the liquid flow channel 122 for guiding and infiltrating the liquid so that the liquid flow channel 122 communicates to a groove for supporting the O ring 121 on the window member fixing jig 120. With this configuration, the liquid can be rapidly infiltrated in a uniform manner from a contact portion of the groove and the window member 110. When the supply amount of the liquid to the window member 110 exceeds an infiltration capacity by the capillary force or the like, the liquid may leak out to the outside. In this case, a member that does not infiltrate the liquid (i.e., a non-infiltrating member that does not allow the liquid to be seeped, for example, a solid resin) may be arranged adjacent to a part of or the entire peripheral portion of the window member 110. With this configuration, the leakage of the liquid out to the outside of the window member can be prevented reliably. In this manner, in a state in which the refractive index difference at the boundary between the surface of the object to be examined and the window member is adjusted, the electromagnetic wave from the object to be examined that is brought into contact with the window member can be sensed by the sensing unit.

### Second Embodiment

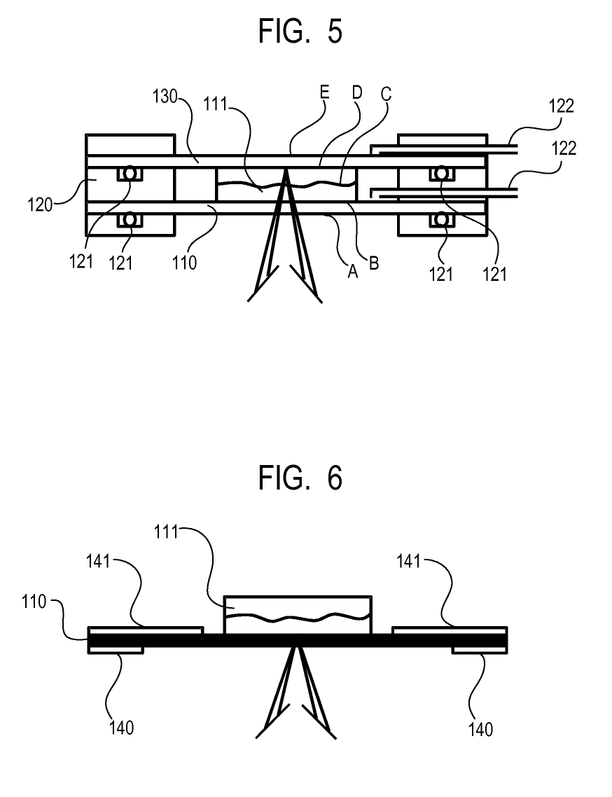

A measuring apparatus according to a second embodiment of the present invention is described below. A description of a part that is similar to the part described above is omitted. FIG. 5 illustrates a configuration according to the second embodiment in which the object 111 to be examined is sandwiched by the window member 110 and a rear-surface window member 130. In this case, the rear-surface window member 130 is newly added, which is brought into contact with a rear surface of the object 111 to be examined as viewed from an irradiation direction of the terahertz wave (from the bottom of FIG. 5). That is, the object to be examined is sandwiched by two porous materials. Each of the window members (the window member 110 and the rear-surface window member 130) includes the dielectric constant adjusting unit 108 in a separate manner.

Each of the window members is fixed by sandwiching the window member by multiple O rings 121 and window member fixing jigs 120. In the time waveform sensed by irradiating the object 111 to be examined that is configured in the above manner with the terahertz wave before adjusting the dielectric constant of the rear-surface window member 130, when the optical length difference between the internal boundary C and a boundary D of the rear surface of the object to be examined is small, the reflection pulses are superimposed. In addition, when acquiring the frequency spectra of the boundary C, the reflection pulse at the boundary D needs to be separated on the time waveform, which is not suitable for a highly-accurate measurement. In order to acquire the information of the internal boundary C of the object 111 to be examined with high accuracy, it is effective to adjust the dielectric constant (refractive index) of the rear-surface window member 130 so that the reflection at the boundary D is eliminated (refractive indexes of the rear-surface window member 130 and a portion between the boundaries C and D of the object to be examined match each other). Further, it is preferred that the liquid to be infiltrated into the rear-surface window member 130 have a high absorbency with respect to the irradiated terahertz wave, in order to eliminate the unnecessary reflection at a boundary E. With this configuration, in addition to the elimination or suppression of the reflection pulse at the boundary B, the reflection pulses at the boundary D and the boundary E on the time waveform can be eliminated or can be suppressed to a sufficiently small value with respect to the reflection amplitude of the boundary C. In this manner, in a state in which the refractive index differences at the boundaries between both surfaces of the object to be examined and the two window members are adjusted, the electromagnetic wave from the object to be examined that is brought into contact with the two window members can be sensed by the sensing unit.

This embodiment can effectively use the rear-surface window member 130 even if the characteristic of the object 111 to be examined is changed due to drying, for example, even for a living organism that contains water. By infiltrating the water into the rear-surface window member 130, the humidity around the object 111 to be examined can be adjusted. Therefore, the water inside the object 111 to be examined can be prevented from being evaporated.

### Third Embodiment

A third embodiment of the present invention is described. A description of a part that is similar to the part described above is omitted. The material for the window member 110 may be a ferroelectric material. Further, a material having no absorbency and a high transmittance with respect to the electromagnetic wave to be irradiated is preferred as the material for the window member 110. In this embodiment, a method of adjusting the dielectric constant of the window member 110 involves generating an electric field in the window member 110 by applying a voltage to the window member 110 by the dielectric constant adjusting unit 108 to change the dielectric constant. That is, the dielectric constant adjusting unit for the window member includes an applying unit for applying an electric field to the window member.

The dielectric constant of the window member 110 can be adjusted by changing the intensity of the electric field. Further, it is desired to select, as the material for the window member 110, a ferroelectric material that causes the dielectric constant of the object 111 to be examined to fall within a dielectric constant variable range that is changed by the electric field. Examples of the ferroelectric material include BaTiO₃ and BaSrTiO₃. For example, when an electric field of several voltages per micrometer is applied to these materials, the dielectric constant can be decreased by about several tens of percent compared to a state before applying the electric field in the terahertz range. When arranging an electrode on the window member in order to apply the voltage to the window member 110, the electrode for applying the voltage to the window member 110 may be arranged in a portion indicated as front-surface and rear-surface reflecting layers 140 and 141 illustrated in FIG. 6, which is described later. A pattern of the electrode may be designed as appropriate.

### Fourth Embodiment

A measuring apparatus according to a fourth embodiment of the present invention is described. A description of a part that is similar to the part described above is omitted. In this embodiment, as illustrated in FIG. 6, the front-surface reflecting layer 140 is provided on a surface of the window member 110, which is not brought into contact with the object 111 to be examined, and the rear-surface reflecting layer 141 is provided on a rear surface (surface opposite to a side that is irradiated with the electromagnetic wave) of the window member 110, which is brought into contact with the object 111 to be examined.

The complex refractive indexes and the complex dielectric constants of the window member 110 and the object 111 to be examined can be calculated in the same manner as the first embodiment, in which the reference is placed on the same position as the reflecting surface of the object to be measured, the frequency spectra are calculated based on the reflection pulses from the reference and the object to be measured, and the complex refractive indexes and the complex dielectric constants are calculated based on the complex amplitude reflections obtained from the frequency spectra. At this time, the front-surface reflecting layer 140 as the reference for the window member 110 and the rear-surface reflecting layer 141 as the reference for the surface of the object to be examined are provided to the window member 110 in advance, and thus a cumbersome procedure of placing the reference for each measurement can be relieved. In this case, it is preferred that the front-surface reflecting layer 140 and the rear-surface reflecting layer 141 be placed on the window member 110 in such a manner that at least an area of the rear-surface reflecting layer in the plane direction is larger than an area of the front-surface reflecting layer in the plane direction outside a region for placing the object to be examined so that the object 111 to be examined, the front-surface reflecting layer 140, and the rear-surface reflecting layer 141 are measured in a continuous manner. In addition, in order to match positions of the object to be measured and the reference, it is desired to include a stage that is configured to move the window member 110 in a lateral direction.

As the material for the reflecting layer, a material that is deemed to provide a reflectance of substantially 100% with respect to the electromagnetic wave to be irradiated is selected. The reflecting layer can be formed, for example, by depositing a film of metal or the like by a vacuum deposition method or the like. It is preferred that a thickness of the reflecting layer be 1 μm or less due to a restriction in aligning the reflecting surfaces. The flatness of the reflecting layer may at least be a surface roughness coefficient equal to or smaller than 1/10 of the wavelength of the electromagnetic wave to be irradiated. In this manner in this embodiment, the reflecting layer of a metal film or the like at least having a surface roughness coefficient equal to or smaller than 1/10 of the wavelength of the electromagnetic wave to be irradiated is formed on a portion of the surface of the window member 110 of the porous material or the like. A reflection wave at the reflecting layer of the thin metal film or the like, which is provided on at least a portion of the surface of the window member and totally reflects the irradiation electromagnetic wave, is then used in the calculation of the complex dielectric constant of each portion.

### Fifth Embodiment

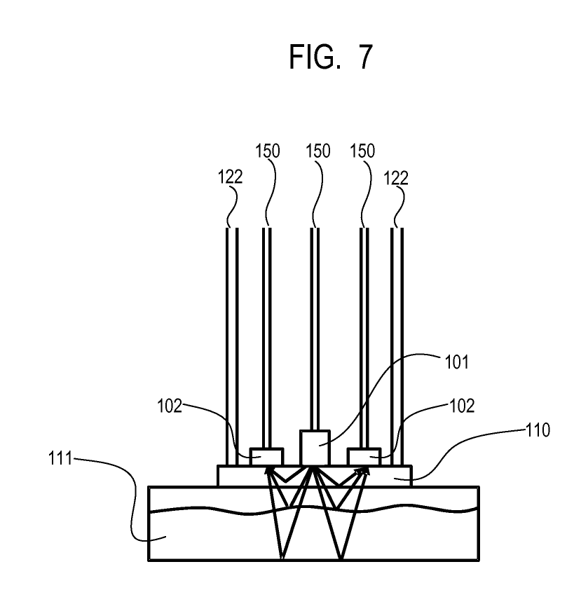

A measuring apparatus according to a fifth embodiment of the present invention is described. A description of a part that is similar to the part described above is omitted. As illustrated in FIG. 7, this embodiment relates to an endoscope including the irradiation unit 101 that irradiates the object 111 to be examined with a terahertz wave, the sensing unit 102 that senses the terahertz wave from the object 111 to be examined, and the window member 110 that is optically brought into contact with the irradiation unit and the sensing unit. That is, this embodiment relates to a contact terahertz imaging probe including a measuring apparatus that faces the object to be examined on one end portion. The liquid flow channel 122 is coupled to the window member 110 so as to render the dielectric constant of the window member 110 to be variable.

For example, an optical waveguide 150 is coupled to and an electric wiring (not shown) is formed on the irradiation unit 101 and the sensing unit 102 that are built in a tube-shaped case of the probe. Each of the irradiation unit 101, the sensing unit 102, and the liquid flow channel 122 may be a single unit or multiple units. It is desired that the terahertz wave irradiated from the irradiation unit 101 be reflected at the window member 110 and the object 111 to be examined without intermediation of the air, and a portion of the reflection terahertz wave be sensed by the sensing unit 102. With this configuration, in a measurement of the object to be examined inside the living organism, the reflection at the surface of the object 111 to be examined can be reduced without generating an unnecessary reflection loss at a boundary with the air, and as a result, the terahertz wave can be propagated through the internal tissue in an efficient manner.

Further, when the porous material is used for the window member 110, mucous membranes, secretions, DNA, and the like collected inside the living organism can be infiltrated into or collected on the window member 110. In addition, by setting the inside of the liquid flow channel to a negative pressure without filling the liquid in the liquid flow channel, the above-mentioned substances infiltrated into the window member can be sucked and extracted outside the organism to be appropriately analyzed. A method of measuring the object to be examined is the same as that of the above-mentioned first embodiment.

### Sixth Embodiment

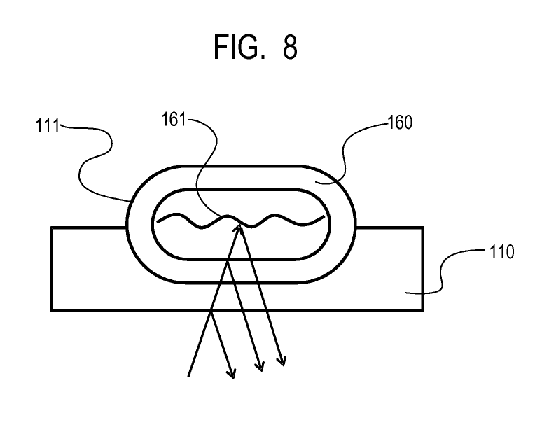

A measuring apparatus according to a sixth embodiment of the present invention is described. A description of a part that is similar to the part described above is omitted. In this embodiment, as illustrated in FIG. 8, a material deformable in accordance with a shape of the object 111 to be examined or a material having a form in accordance with the shape of the object 111 to be examined is used as the window member 110. With this configuration, when the object to be examined is as hard as a medical tablet so that it cannot be deformed or when a surface profile of the object to be examined is not flat, the window member 110 can be deformed in accordance with the shape of the object 111 to be examined, resulting in an increase of a contact surface with the object 111 to be examined. Alternatively, the window member 110 that is formed in accordance with the surface profile may be prepared to increase the contact surface with the object 111 to be examined. By using the window member 110 described above, a scattering at the surface of the medical tablet can be prevented, and information on the medical tablet, such as thickness and peeling of a film coat 160, an internal defect 161 such as a crack, and distribution of a medical agent, can be acquired. A method of measuring the object to be examined is the same as that of the above-mentioned first embodiment.

In the following, more specific examples are described.

### Example 1

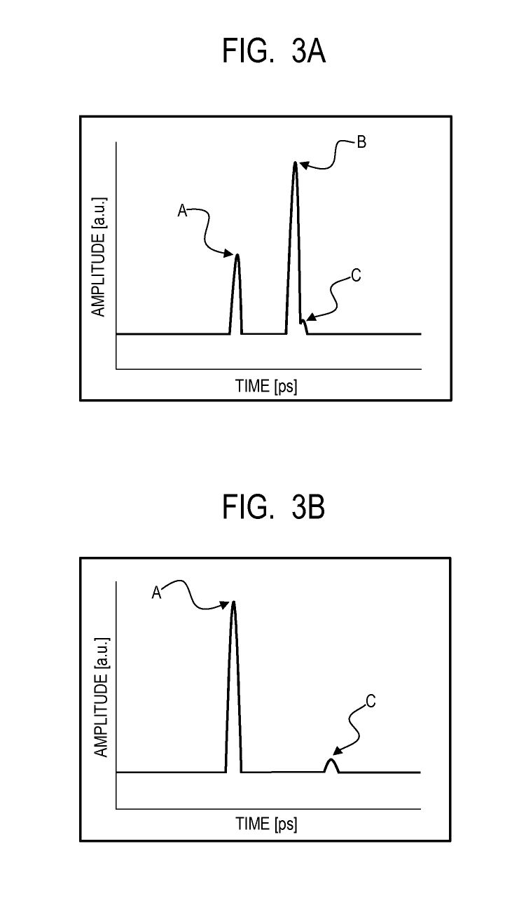

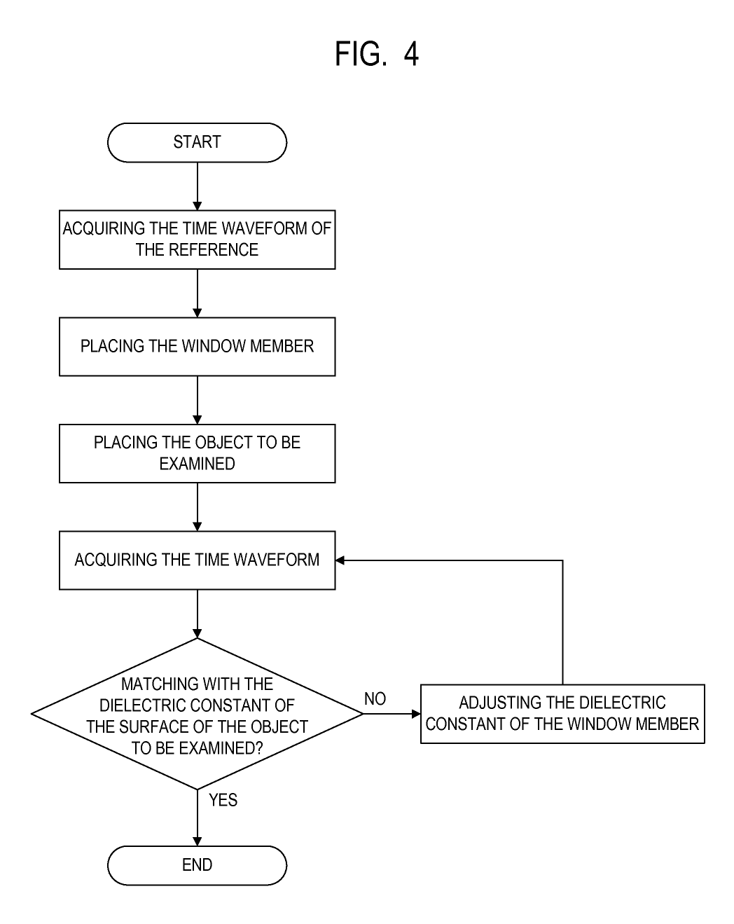

FIGS. 3A and 3B are graphs schematically showing time waveforms of the terahertz wave pulse sensed by the apparatus illustrated in FIG. 1. In Example 1, the surface (boundary B) of the object 111 to be examined is a thin film (thickness of a portion between the boundaries B and C is 30 μm, refractive index of the portion is 2, and no absorption and no dispersion occur), including the internal boundary C (thickness of a portion upper than the boundary C is infinite (can be deemed to be infinite because it is considerably thicker than the above-mentioned thin film), refractive index of the portion is 2.1, and no absorption and no dispersion occur). The window member 110 (thickness is 300 μm, refractive index is 1.2, and no absorption and no dispersion occur) is placed on the object 111 to be examined described above. A full width at half maximum of the terahertz wave pulse which irradiates the window member 110 and the object 111 to be examined is set to 300 fs.

The terahertz wave has a large wavelength, and hence a range of focus of the terahertz wave is submillimeters to several millimeters. In addition to this, the terahertz wave enables a measurement of a terahertz wave pulse that is reflected at a portion other than the focusing region. Therefore, when there exist multiple refractive index boundaries (A, B, and C) in the window member 110 and the object 111 to be examined as illustrated in FIG. 1 and these boundaries exist within a measurable range including the focal point, the terahertz wave pulse is measured as shown in FIG. 3A in a state in which multiple reflection pulses (A, B, and C) appear in a row. In the reflection pulses which reflect the refractive index difference between the boundaries (A, B, and C), the reflection amplitude of the boundary C is about 1/20 of the reflection amplitude of the boundary B because the refractive index difference at the boundary C (Δn=0.1) is smaller than the refractive index difference at the boundary B (Δn=0.8). In addition, the surface of the object 111 to be examined is a thin film, and hence the optical length difference between the boundaries B and C to be sensed is small so that the reflection pulses are sensed in a superimposed manner.

Therefore, in order to separate the reflection pulses of the boundary B and the boundary C from each other, it is required to use a numerical calculation such as a deconvolution and a regression analysis or to shorten a pulse width of the terahertz wave to be irradiated. Further, when acquiring the frequency spectra of the boundary B and the boundary C in a separate manner, regarding the boundary B, an irradiation angle of the terahertz wave pulse is adjusted to totally reflect the terahertz wave pulse at the boundary B so that the frequency spectra are separately acquired. However, regarding the boundary C, it is more difficult to acquire the information because it is required to separate the information of the boundary C from the information of the boundary B on the time waveform.

In this embodiment, for example, the dielectric constant of the window member 110 is adjusted up to the same refractive index (dielectric constant) as that of a portion of the object to be examined that defines the boundary B with respect to the window member 110 and the object 111 to be examined that are configured in the above-mentioned manner. With this operation, the reflection pulse at the boundary B can be eliminated or can be reduced to a sufficiently small value with respect to the reflection amplitude of the boundary C. In this manner, the multiple reflection pulses (A, B, and C) can be obtained, for example, as shown in FIG. 3B (the reflection pulse B is eliminated) with respect to the window member 110 and the object 111 to be examined having the same configuration as that of the case shown in FIG. 3A.

A specific step to be performed until adjusting the dielectric constant of the window member to the same refractive index (dielectric constant) as that of the portion of the object to be examined between the boundaries B and C is described. A flow illustrated in FIG. 4 is the simplest way. The dielectric constant (refractive index) of the window member 110 before adjusting the dielectric constant is assumed to be known. Firstly, the time waveform of the reflection wave of the reference is acquired, and then transferred to the dielectric-constant change detecting unit 107. The reference may be a flat substrate on which Au, Ag, Al, or the like is deposited. Subsequently, the object 111 to be examined is placed on the window member 110, and the time waveforms of the reflection pulses from the boundaries (A, B, and C) are acquired. At this time, information (amplitude and phase) of the reflection wave at the boundary B depends on values of the dielectric constants (refractive indexes) of the window member 110 and the surface of the object 111 to be examined. The information (amplitude and phase) of the reflection at the boundary B is then transferred to the dielectric-constant change detecting unit 107. The dielectric-constant change detecting unit 107 calculates the dielectric constant difference (refractive index difference) between the window member 110 and the surface of the object 111 to be examined based on the information of the reference and the information of the reflection at the boundary B. An instruction for adjusting the dielectric constant (refractive index) of the window member is then issued to the dielectric constant adjusting unit 108 so as to match the dielectric constant (refractive index) of the window member 110 with the dielectric constant (refractive index) of the surface of the object 111 to be examined. The dielectric constant adjusting unit 108 performs a dielectric constant adjustment for the window member 110 following the instruction. After performing the dielectric constant adjustment, the time waveform acquiring unit 106 acquires the time waveforms of the reflection pulses from the boundaries (A, B, and C) again, and the information (amplitude and phase) of the reflection at the boundary B is transferred to the dielectric-constant change detecting unit 107. By repeatedly performing these steps, the dielectric constants (refractive indexes) of the window member 110 and the surface of the object 111 to be examined can be finally matched with each other. Therefore, by eliminating or suppressing the reflection at the boundary B, the information of the boundary C can be sensed with high accuracy.

When the porous material is used for the window member 110, for example, a membrane filter (product number: 60172, material is hydrophilic polyethersulfone, and the average pore diameter is 0.45 μm) manufactured by Japan Pall Corporation can be used. The liquid to be infiltrated into the window member 110 is described. In order to match the refractive index of the window member 110 with the refractive index (n=2) of the portion of the object to be examined between the boundaries B and C as described in the above-mentioned example, it is desired that the liquid to be infiltrated into the window member 110 be a liquid at least having a refractive index equal to or larger than the refractive index of the portion of the object to be examined between the boundaries B and C. In this case, for example, water, ionized water, or the like can be used. The refractive index of the porous material is determined by a presence ratio between the porous material on the optical path through which the terahertz wave passes and a medium that occupies the pores, and a refractive index of each portion. That is, the refractive index is lowest when the air (n=1) occupies the inside of the porous material (n=about 1.2 in the case of the above-mentioned membrane filter), and the refractive index of the entire porous material can be increased by infiltrating a liquid that is a medium having a refractive index larger than that of the air into the porous material. As another example other than the above-mentioned example, when isopropyl alcohol is used as the infiltrating liquid, the refractive index of the window member 110 can be adjusted in a range of about 1.2 to 1.6 depending on the presence ratio between the porous material of the polyethersulfone and the isopropyl alcohol occupying the pores of the porous material.

The refractive index of the window member 110 can be adjusted by adjusting the refractive index unique to the liquid and the infiltrating amount of the liquid based on the above-mentioned facts. When the water is used as the liquid to be infiltrated, the refractive index of the porous material can be returned to a state in which the original air occupies the pores of the porous material in a reversible manner by drying the porous material so that the water inside the porous material is evaporated. A method of adjusting the refractive index of the window member 110 with respect to the refractive index (n=2) of the portion of the object to be examined between the boundaries B and C when the water is selected as the liquid to be infiltrated into the window member 110 is considered. The refractive index of the window member 110 in the terahertz wave range when the window member 110 was infiltrated only with water was a value larger than the refractive index of the portion of the object to be examined between the boundaries B and C (for example, n=2.1 at 1 THz). In addition, the evaporation amount of the water in the porous material has a correlation with the refractive index of the window member 110, and hence the evaporation amount of the water is larger as the refractive index of the window member 110 is larger. Thus, a decrease of the refractive index of the window member 110 was significant. With such a phenomenon, the refractive index of the window member 110 was successfully matched with the refractive index of the portion of the object to be examined between the boundaries B and C by continuously infiltrating the water of a constant amount into the window member to keep an evaporation amount of the water constantly. Detection and adjustment of the change of the dielectric constant (refractive index) of the window member 110 can be performed by using an apparatus having the configuration illustrated in FIG. 1.

A skin of a human body is adopted as an example of the object 111 to be examined. A surface of the skin of the human body includes a stratum corneum that is a thin film of about several tens of μm and an epidermis thereinside. In a conventional method of acquiring information of the epidermis by removing information of the stratum corneum from information of the reflection pulse at the skin by using a numerical calculation, an electrical noise of the sensing unit 102 and the information of the epidermis cannot be distinguished from each other, and as a result, a portion of the information of the epidermis has been removed through the numerical calculation. However, with the measuring apparatus according to the present invention, the information of the stratum corneum can be removed without removing the information of the epidermis, and hence the information of the epidermis can be acquired from the reflection pulse of the boundary of the epidermis with high accuracy.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-109394, filed May 11, 2012, which is hereby incorporated by reference herein in its entirety.

1. A measuring apparatus comprising:
an object to be examined;
a window member configured to be brought into contact with the object to be examined;
an irradiation unit configured to irradiate the object to be examined and the window member with a terahertz wave;
a sensing unit configured to sense the terahertz wave from the object to be examined and the window member;
a time waveform acquiring unit configured to acquire, by using a sensing signal from the sensing unit, a time waveform of the terahertz wave from the object to be examined and the window member; and
a dielectric constant adjusting unit configured to adjust a dielectric constant of the window member based on the time waveform acquired by the time waveform acquiring unit.

2. (canceled)

3. The measuring apparatus according to claim 1, further comprising a dielectric-constant change detecting unit configured to detect a change of the dielectric constant of the window member based on a signal of the terahertz wave from the object to be examined that is brought into contact with the window member, the terahertz wave being sensed by the sensing unit.

4. The measuring apparatus according to claim 3, wherein the dielectric constant adjusting unit is configured to change, based on the change of the dielectric constant of the window member that is detected by the dielectric-constant change detecting unit, the dielectric constant of the window member so that a refractive index difference between the window member and a surface of the object to be examined is decreased.

5. The measuring apparatus according to claim 3, wherein the change of the dielectric constant of the window member is detected by calculating a complex amplitude reflectance based on a signal of a reflection wave from the window member that is sensed by the sensing unit and calculating a complex refractive index and a complex dielectric constant based on the complex amplitude reflectance.

6. The measuring apparatus according to claim 5, wherein the window member comprises a reflecting layer configured to totally reflect the terahertz wave, the reflecting layer being provided on at least a portion of a surface of the window member; and
wherein the complex dielectric constant is calculated by using a signal of a reflection wave from the reflecting layer that is sensed by the sensing unit.

7. The measuring apparatus according to claim 1, wherein the dielectric constant adjusting unit comprises:
an infiltrating unit configured to infiltrate a liquid of at least one type into the window member; and
a liquid-infiltration-amount adjusting unit configured to independently adjust an infiltration amount of the liquid.

8. The measuring apparatus according to claim 1, wherein the window member is made of a porous material.

9. The measuring apparatus according to claim 8, wherein the porous material comprises two porous materials sandwiching the object to be examined therebetween.

10. The measuring apparatus according to claim 8, wherein the porous material comprises at least one reflecting layer having a surface roughness coefficient equal to or less than 1/10 of a wavelength of the terahertz wave which irradiates a portion of a surface of the porous material.

11. The measuring apparatus according to claim 8, wherein the liquid-infiltration-amount adjusting unit is configured to adjust the infiltration amount of the liquid by using a database configured to store a relationship between a complex dielectric constant of the porous material and one of at least one of information on the porous material and information on the liquid and a combination of the information on the porous material and the information on the liquid.

12. The measuring apparatus according to claim 7, wherein the liquid comprises at least one of water, saline, oil, ionized water, formalin, phosphate buffer solution, organic compound, cell culturing medium, sugar, hormone, protein, amino acid, and cytokine.

13. The measuring apparatus according to claim 1, wherein the dielectric constant adjusting unit comprises an applying unit configured to apply an electric field to the window member.

14. The measuring apparatus according to claim 1, wherein the window member is deformable in accordance with a surface profile of the object to be examined.

15. (canceled)

16. A contact probe comprising:
the measuring apparatus according to claim 1;
an optical waveguide connected to one of the irradiation unit and the sensing unit; and
a liquid flow channel of the dielectric constant adjusting unit that is connected to the window member.

17. A measuring method using a terahertz wave, the measuring method comprising the steps of:
bringing a window member into contact with an object to be examined;
irradiating the window member and the object to be examined with the terahertz wave;
sensing the terahertz wave from the window member and the object to be examined to acquire a sensing signal;
acquiring, by using the sensing signal, a time waveform of the terahertz wave from the window member and the object to be examined; and
adjusting a dielectric constant of the window member based on the time waveform.
